(19) United States
(12) Patent Application Publication
(10) Pub. No.: US 2006/0291397 A1
(43) Pub. Date: Dec. 28, 2006

(54) Method and device for determining and optionally for evaluatiing disturbances and/or interruptions in the communication with domestic appliances

(76) Inventors: Theo Buchner, Neustadt (DE); Udo Hertel, Regensburg (DE); Horst Werkmann, Pfaffenhofen/Ilm (DE)

Correspondence Address: LERNER GREENBERG STEMER LLP, P O BOX 2480, HOLLYWOOD, FL, 33022-2480, US

(21) Appl. No.: 10/546,842

(22) PCT Filed: Feb. 23, 2004
(86) PCT No.: PCT/EP04/01771

§ 371 Date: Sep. 11, 2006

(30) Foreign Application Priority Data
Feb. 24, 2003 (DE) 10307826.6

(51) Int. Cl. H04L 12/26

(52) U.S. Cl. 370/241

(57) ABSTRACT

The aim of the invention is to determine and optionally evaluate sporadic or constant disturbances and/or interruptions in the communication with domestic appliances (A1 . . . Am, An) that are connected to communication units (BCU1 . . . BCUm, BCUn) in order to transmit and/or receive communication signals by means of a first communication network (HB) which can be connected to at least one external control and/or monitoring unit (PC) via at least one transition device (GW) and a second optional communication network (NET), particularly a public communication network. Said aim is achieved by activating a test program in the at least one transition device (GW) that is connected to the first communication network (HB) when said disturbances and/or interruptions occur, the disturbances and/or interruptions occurring in the first communication network (HB) being detected and optionally evaluated as to the type, extent, and duration thereof by means of said test program.

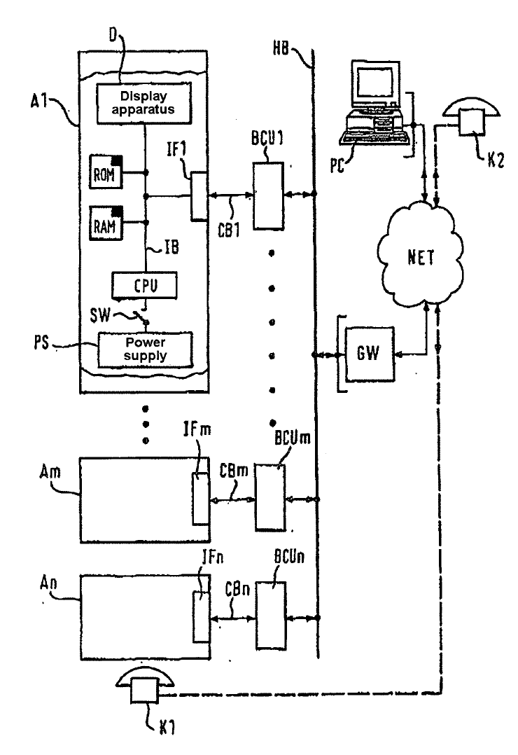

The invention relates to a method and to a device for determining and optionally for evaluating brief or continuous disturbances and/or interruptions in the communication with domestic appliances which are connected to communication units for transmitting and/or receiving communication signals by a first communication network which can be connected to at least one external control and/or monitoring device via at least one gateway device and optionally via a second communication network, in particular a public communication network.

In order to communicate with domestic appliances for control and monitoring purposes, it is known (WO 99 65192 A) to connect the domestic appliances in question to a local area network (LAN). In the context concerned, this involves operating the domestic appliances in question with programs and/or services which are made available over the Internet by service providers. The software of the service required for the respective domestic appliance is made available by the service provider in question, via the Internet, to a network operator server and/or a service platform server which is connected to the abovementioned communication network. However, in the context under consideration, nothing is known about disturbances or interruptions which may occur when communicating with the domestic appliances or about measures for determining and optionally for evaluating these kinds of disturbances and/or interruptions.

A method and a device for defining programmable features of one of a multiplicity of devices are also known (WO 00 43870 A). In the context concerned, devices are domestic appliances such as refrigerators, conventional ovens, microwave ovens, dishwashers, ventilation and air-conditioning devices, home-security systems etc. Said domestic appliances are connected to a global computer network via which desired programs can be made available to the domestic appliances in question. The connections of the domestic appliances in question to access devices to said global computer network may be wire-connected or wireless connections. The use of a power supply line between a domestic appliance and a service provider for transmitting instructions is also discussed in conjunction with wire-connected connections in the context concerned. However, nothing is known in this context either, even very generally, about disturbances or interruptions occurring in the case of communication operations of this type with the domestic appliances or about measures for determining and optionally for evaluating theses types of disturbances and/or interruptions.

Finally, it has been proposed (DE 102 08147.6) in conjunction with the control and monitoring of domestic appliances to connect the domestic appliances in a building via a first communication network to what is known as a residential gateway, which is a building gateway computer apparatus or in general a gateway device. This gateway device can be connected to a second communication network, to be precise in particular to a public communication network, to which, inter alia, an administration computer and an external control unit can be connected which may be connected to the abovementioned domestic appliances. Although a multiplicity of communication operations which are carried out between various devices are described in the context concerned, disturbances and/or interruptions occurring in the course of the respective communication, or measures for determining these types of disturbances and/or interruptions and optionally for evaluating them, are not discussed.

Although the communication operations with the mentioned domestic appliances can generally be performed in a device of the type mentioned in the introduction without any problems in the majority of cases, the respective communication may in some cases be impaired by brief disturbances or even interrupted by long disturbances. In these cases, it has to date only been possible to determine the type, the extent and the duration of the respective disturbance only by time-consuming and costly measurements in the communication network in question. It should be mentioned in this context that, for example, a reliability of 98% can be assumed during data transmission via power supply lines (for this purpose see Manual 2000, “Sehen statt Hören mit dem HGT-Lichtsystem [Seeing instead of hearing using the HGT light system]”, LS Manual 2000_pdf).

Therefore, in the case of brief or long-lasting disturbances and/or interruptions occurring in the communication with domestic appliances, measures are to be taken to determine and optionally evaluate such disturbances.

The invention is therefore based on the object of showing a way in which brief or continuous disturbances and/or interruptions in the communication with domestic appliances can be determined and optionally evaluated in the case of a method and a device of the type mentioned in the introduction in a relatively simple manner without the need for time-consuming and costly measurements, in particular by additional personnel being on site and using corresponding measuring means.

According to the invention, the abovementioned object is achieved in the case of a method of the type mentioned in the introduction in that a test program is activated in the at least one gateway device connected to said first communication network in response to the occurrence of said disturbances and/or interruptions, said test program being used to detect the disturbances and/or interruptions occurring in the first communication network in question and optionally evaluate them in terms of type, extent and duration.

The advantage of the invention is that disturbances and/or interruptions in the communication with the domestic appliances which occur in each case can be determined in a particularly simple manner, specifically without time-consuming and costly measurements being carried out on site by additional personnel, and that the disturbances and/or interruptions in question can be evaluated optionally in terms of their type, extent and duration. It is thus possible, in a particularly simple manner, to statistically evaluate and obtain information about the quality of the communication medium, that is to say the mentioned first communication network, as regards disturbances and/or interruptions. It is therefore possible, for example, to establish whether there is possibly a fault in the domestic appliances connected to the first communication network in question themselves, or whether the disturbances and/or interruptions are caused by other devices or services, for example.

Activating said test program preferably switches the communication units of the domestic appliances belonging to said first communication network to a specific fixed mode in which the communication units in question communicate in accordance with a defined protocol, and, in the course of the communication in accordance with this defined protocol, the disturbances and/or interruptions occurring in the first communication network in question are determined and optionally evaluated in terms of type, extent and duration. This provides the advantage of particularly reliable determination and optionally evaluation of brief or continuous disturbances and/or interruptions in the communication with the mentioned domestic appliances. Communication in accordance with the mentioned defined protocol allows conclusions to be drawn in a particularly simple manner, specifically in the case of brief or continuous disturbances and/or interruptions, as to whether the disturbances and/or interruptions in question can be attributed to the domestic appliances and/or their first communication network or originate from other disturbing influences.

Said test program is expediently activated in the gateway device in question by a control and/or monitoring device, which can be connected to said gateway device, in response to a separate message transmitted to this device by at least one of said domestic appliances and/or by a further communication device associated with said domestic appliance. This has the advantage that said test program can be activated by the mentioned control and/or monitoring device in response to an individual message. In this case, the test program in question can either already itself be installed in said monitoring device, or be loaded into this monitoring device by the mentioned control and/or monitoring device in a controlled manner in order to be activated. In this context, it is also possible for, for example, different test programs to be made available and be used depending on the reported disturbance and/or interruption.

As an alternative to the measure considered above, the activation of said test program in the gateway device in question is initiated automatically by the gateway device in question itself after said gateway device has determined disturbances and/or interruptions in the first communication network by monitoring said first communication network sporadically or at relatively large time intervals. The advantage of a particularly simple automatic determination and optionally evaluation of disturbances and/or interruptions in the communication with the mentioned domestic appliances is achieved by means of this measure. In terms of loading the test program or different test programs, the same applies here as has been explained above, but with the proviso that the gateway device in question itself optionally downloads the test program or programs from a defined program source.

Said test program for monitoring the first communication network in question is expediently activated for a fixed period of time. In this way, it is possible to draw conclusions about possible sources of disturbance in a particularly simple manner, in particular when the time period in question is fixed at 24 hours, for example, and the disturbances and/or interruptions occur only during specific hours or minutes.

Said first communication network can be operated either as a line-connected communication network comprising communication lines, power supply lines, which are fed by a mains voltage source, of the individual domestic appliances in particular being used as the communication lines of said communication network, or said communication network can be operated as a radio network in which the individual domestic appliances communicate by means of transceivers which form the communication units. Both cases have the advantage of a first communication network which is relatively easy to set up.

In order to carry out the method according to the invention, use is preferably made of a device having a first communication network which connects domestic appliances for carrying out communication operations, to which communication network at least one gateway device is or can be connected, and at least one external monitoring and control device is or can be connected to said gateway device optionally via a further communication network, in particular a public communication network. This device is characterized in that a separate test program is or can be stored in the gateway device connected to said first communication network, this test program being designed for determining said disturbances and/or interruptions in the communication network in question and, in response to being activated, allowing the disturbances and/or interruptions occurring in the communication network in question to be detected and optionally evaluated in terms of type, extent and duration. This results in the advantage of particularly little effort being required to determine and optionally evaluate disturbances and/or interruptions in the communication with domestic appliances connected to said first communication network.

Said test program in question can expediently be activated in and optionally loaded beforehand into said gateway device or devices by the monitoring and control device which is connected to the gateway device in question, optionally via said further communication network. This provides the advantage that said test program can be activated by the mentioned control and/or monitoring device in response to an individual message with particularly little outlay on circuitry.

As an alternative to the expedient development of the device according to the invention and just considered above, it is possible for said test program to be activated in and optionally loaded beforehand into the gateway device in question by said gateway device itself after it has determined disturbances and/or interruptions in said first communication network by monitoring this communication network sporadically or at relatively large time intervals. This results in the advantage that particularly simple automatic determination and optionally evaluation of disturbances and/or interruptions in the communication with the mentioned domestic appliances are achieved with particularly little outlay on circuitry.

The invention is explained in greater detail below using one exemplary embodiment and with reference to a drawing.

The drawing schematically illustrates a multiplicity of domestic appliances A1 . . . Am, An which are connected to a first communication network HB via communication units BCU1 . . . BCUm, BCUn. This communication network HB can be connected to at least one external control and/or monitoring device PC via at least one gateway device GW and a second communication network NET which is connected to said gateway device.

The fact that several gateway devices GW and external control and/or monitoring devices PC can be provided is indicated in the drawing by multiplication signs on the connecting lines in question. One such multiplication sign is therefore provided on the connecting line connecting the one illustrated gateway device GW to the first communication network HB, and a further multiplication sign is provided on the connecting line connecting the illustrated control and/or monitoring device PC to the second communication network NET.

The domestic appliances A1 . . . Am, An indicated in the drawing are, for example, similar or different domestic appliances which belong to one household or to a plurality of households, such as a washing machine, an electric cooker, a dishwasher, a microwave oven, a refrigerator, a vapor-extraction hood, an air-conditioning system, a coffee machine, a vacuum cleaner, a hob or a freezer. The domestic appliances A1 . . . Am, An in question are not illustrated in detail here; instead only the elements which are necessary for understanding the present invention are shown, more specifically only in terms of the domestic appliance A1.

The abovementioned elements of the domestic appliance A1 include, inter alia, a central processing unit CPU which is connected to an internal bus IB to which a read-only memory ROM and a random-access memory RAM and a display apparatus D are also connected. Operating programs which can be executed using the central processing unit CPU and serve the purpose of operating the domestic appliance A1 may be stored in the read-only memory ROM. The random-access memory RAM serves as a main memory of the illustrated computer system while operating programs of this type are being executed.

The central processing unit CPU is connected via a switch SW indicated in the drawing to a power supply device PS which in this case is a dedicated or separate power supply device for the domestic appliance A1 and which, for example, is still available when the supply or mains voltage which serves for operating the domestic appliance A1 in question fails, in order for the illustrated computer system to be able to provide specific state and/or message signals for a possible remote interrogation.

In the present case, an interface device IF1 is also connected to the internal bus IB of the domestic appliance A1, this interface device serving for communication connections to and from the domestic appliance A1 in question. The interface device IF1 in question may, for example, be a serial or parallel interface device, as is customarily used for data transmission purposes. The abovementioned remote interrogation may be performed via this interface device IF1, for example.

As for the remaining domestic appliances Am and An illustrated in the drawing, it should be noted that these can be set up in the same way as the domestic appliance A1 described above. The two domestic appliances Am and An are each equipped with their own interface devices IFm and, respectively, IFn which correspond to the abovementioned interface device IF1. These interface devices IFm, IFn may likewise be parallel or serial interface devices.

The interface devices IF1 . . . IFm, IFn of the domestic appliances A1 . . . Am, An are connected to associated communication units BCU1 . . . BCUm, BCUn via connection lines CB1 . . . CBm, CBn illustrated in the drawing as bidirectional connecting lines. In the present case, these communication units may be formed by what are known as bus coupling units. The domestic appliances A1 . . . Am, An are connected via these bus coupling units or bus couplers BCU1, BCUm, BCUn to a first communication network which is illustrated in the drawing by a line-connected communication network which comprises a single bus line and may have a multiplicity of individual lines. In the situation where the domestic appliances A1 . . . Am, An are, for example, in one house or in adjacent houses, the bus line HB which forms the mentioned first communication network may be what is known as a home bus which constitutes the first communication network for all of the domestic appliances present in the house or houses in question.

It should be noted at this point that the first communication network HB may also be a line-connected communication network whose communication lines are formed by power supply lines, which are fed by a mains voltage source, of the individual domestic appliances. This means that, in this case, the bus coupling units BCU1 . . . BCUm, BCUn and the gateway device GW communicate with each other via power supply lines of the individual domestic appliances which are connected to the bus coupling units BCU1 . . . BCUm, BCUn in question.

Moreover, the first communication network HB may also be operated as a radio network in which the individual domestic appliances communicate by means of transceivers which then fulfill the functions of the mentioned bus coupling devices BCU1 . . . BCUm, BCUn.

At least one gateway device GW is connected to the bus line HB which forms the first communication network in the present exemplary embodiment, the first communication network in question being connected to a second communication network NET, which is preferably a public communication network, for example the Internet, via said gateway device. As indicated in the drawing, at least one external control and/or monitoring device, which may be formed by a personal computer PC for example, is connected to the second communication network NET in question.

If there are several gateway devices GW and control and/or monitoring units, the gateway devices in question may be connected to different second communication networks, for example, or allow the communication load in the first communication network to be increased. The several control and/or monitoring units may be designed to carry out different control and/or monitoring tasks.

In addition to the devices considered above, the drawing also illustrates two communication devices K1, K2 which may be formed by telephone apparatuses, for example, and of which the communication device K1 is associated with all of the domestic appliances A1 . . . Am, An for example, and the communication device K2 is associated with the external monitoring and control device PC. It should be noted at this point that several said communication devices K1 may be provided, and that each of these communication devices may be associated with one of the domestic appliances A1 . . . Am, An in question. It should also be noted that it is not absolutely necessary to provide these further communication devices K1, K2, but that these may be provided only as required, as illustrated by the dashed connecting lines between the communication devices K1, K2 in question and the second communication network NET.

Since the design of the device or arrangement illustrated in the drawing has already been explained to the extent required for understanding the invention, the method according to the present invention will now be described in greater detail.

However, a few method sequences which take place in the individual domestic appliances A1 . . . Am, An should first be briefly described.

If, for example, the domestic appliance A1 is a washing machine which is currently operating, this operation is being run by a washing program stored in the read-only memory ROM by means of the central processing unit CPU. Program state values occurring in the individual program steps or required for these steps are stored in the random-access memory RAM and can optionally be displayed on the associated display device D.

If, for example, wash program data about the washing stage reached is required by other domestic appliances, such as a tumble dryer which is also connected to the first communication network HB, the communication signals required for this purpose are transmitted to the first communication network HB by the domestic appliance A1 via its interface device IF1 and the bus coupling unit BCU1 connected to said interface device, and are transmitted to the associated tumble dryer, which may be formed by the domestic appliance Am for example, via this first communication network HB and the bus coupling unit in question, for example the bus coupling unit BCUm. Said domestic appliance Am or the tumble dryer forming this domestic appliance can therefore, for example, take preparatory measures for imminent drying, such as preheating, of the laundry still in the mentioned washing machine.

However, in addition to the abovementioned communication between domestic appliances which are connected to the first communication network HB, the individual domestic appliances A1 . . . Am, An are also involved in other communication operations. One such communication operation occurs for example when an updated program has to be loaded into one of the domestic appliances in question. A loading operation of this type may, for example, be performed by the external control and/or monitoring device PC (illustrated in the drawing) via the second communication network NET and the one illustrated gateway device GW to the first communication network HB and from this first communication network to the domestic appliance in question via the associated bus coupling unit of this domestic appliance.

Other communication operations with one of the domestic appliances A1 . . . Am, An under consideration may, for example, be remote diagnosis by the mentioned external control and/or monitoring device PC, or remote monitoring of the domestic appliance in question by this external control and/or monitoring device PC.

In each of the communication operations considered above, control and/or data signals are transmitted via the first communication network HB. In order to ensure reliable communication via this first communication network HB in this case, corresponding safety measures have to be taken in this first communication network and in the respective transmission of signals and communication operation. However, it is equally possible for communication operations performed via the first communication network HB to be disturbed, to be precise briefly or sporadically or even continuously, as a result of which communication via the first communication network HB in question is possibly blocked. Moreover, this does not apply only in the case of a first communication network HB which is operated as a line-connected communication network and has its own communication lines, but also in the case of the first communication network HB in question being operated as a radio network in which the individual domestic appliances communicate by means of transceivers which then fulfill the functions of the abovementioned bus coupling devices BCU1, BCUm, BCUn. In the case of a first communication network HB operated as a line-connected communication network, it should also be noted that it may even have a greater susceptibility to faults when its communication lines are formed by power supply lines, which are fed by a mains voltage source, of the individual domestic appliances. In the case of such a first communication network HB which is formed by power supply lines of the domestic appliances A1 . . . Am, An, disturbances which may lead to the transmitted communication signals being corrupted or lost during the communication operations described may be coupled into this communication network in spite of intensive filtering measures in the bus coupling devices BCU1, BCUm, BCUn and in the gateway device GW.

In order to determine and optionally evaluate disturbances and/or interruptions in the communication with the domestic appliances A1 . . . Am, An, provision is made in the present invention for a test program to be activated in the at least one gateway device GW connected to said first communication network HB in response to the occurrence of the disturbances and/or interruptions in question, said test program being used to detect the disturbances and/or interruptions occurring in the first communication network HB in question and optionally evaluate them in terms of type, extent and duration. The mentioned gateway device GW is virtually the only secure device which, so to speak, can be reached from the outside, that is to say outside the first communication network HB, in order to determine the mentioned disturbances and/or interruptions, and to evaluate the corresponding information about these disturbances and interruptions in the gateway device GW in question or conduct said information to the mentioned external monitoring and/or control device PC for the purposes of an evaluation of this type. In any case, the domestic appliances A1 . . . Am, An cannot fulfill this task in the event of the communication with the first communication network HB being interrupted, and they can only fulfill the function in question only in a very unreliable manner, if at all, in the event of brief or sporadic disturbances in the communication operation in question.

In order to carry out the test using the abovementioned separate test program in a particularly efficient manner, activating said test program expediently switches the communication units, that is to say the bus coupling units BCU1 . . . BCUm, BCUn of the domestic appliances A1 . . . Am, An belonging to said first communication network HB, to a specific fixed mode in which the communication units BCU1 . . . BCUm, BCUn in question communicate in accordance with a defined protocol. In this case, in the course of the communication in accordance with this defined protocol, the disturbances and/or interruptions occurring in the first communication network HB in question can be determined and optionally evaluated in terms of type, extent and duration, to be precise preferably in said gateway device GW.

However, it is also feasible in general for the relevant determination and evaluation of the mentioned disturbances and/or interruptions to be made at another point, for example in the external control and/or monitoring device PC illustrated in the drawing. The important factor here is, however, that the mentioned test program is activated in the illustrated gateway device GW. In order to be able to perform this activation, the mentioned test program is either already stored in the gateway device GW in question, or it is separately saved into this gateway device GW, for example using the mentioned control and/or monitoring device PC, after said control and/or monitoring device has received a message about the presence of the mentioned disturbances and/or interruptions. In principle, a message such as this can be passed from one of the domestic appliances A1 . . . Am, An, via the illustrated communication networks, to the control and/or monitoring device PC in question. However, at least in the event of the communication operations in the first communication network HB being interrupted, this message cannot reach the desired destination. In this case, the alternative communication connection (illustrated in the drawing) between the abovementioned communication devices K1 and K2 can therefore be used in order to allow the control and/or monitoring device PC to receive, via this communication path, a message to activate the mentioned test program in said gateway device GW or optionally to install said test program in the gateway device beforehand.

The above-described measures according to the invention for determining and optionally for evaluating brief or continuous disturbances and/or interruptions in the communication with the domestic appliances A1 . . . Am, An therefore make it possible to nevertheless determine and optionally evaluate the disturbances and/or interruptions in question without the need for additional outlay on personnel on site, that is to say at that site where the domestic appliances A1 . . . Am, An in question are located. In this case, it is possible to determine whether the disturbances and/or interruptions which have occurred or are occurring can be attributed to the individual domestic appliances A1 . . . Am, An or their associated bus coupling units BCU1 . . . BCUm, BCUn, or whether other sources are responsible for the disturbances and/or interruptions in question, precisely by defining the communication mode in the individual communication units BCU1 . . . BCUm, BCUn and by carrying out communication operations in accordance with a defined protocol. In this context, the activation of the mentioned test program which takes place over a fixed time period of, for example, 24 hours allows sources of disturbance which are active only for a limited duration within this period of time to be identified relatively easily.

1-20. (canceled)

21. A method for determining occurring faults and/or blockages in communication with domestic appliances, the method comprising the following steps:
providing a first communications network;
connecting communications units to the first communications network;
connecting the domestic appliances to the communications units for giving and/or receiving communications signals over the first communications network;
connecting at least one transfer device to the first communications network;
providing at least one external control and/or monitoring appliance to be connected to the at least one transfer device; and
activating a test program in the at least one transfer device when the faults and/or blockages occur, for assessing the faults and/or blockages occurring in the first communications network.

22. The method according to claim 21, wherein:
the activating of the test program sets the communications units connected to the domestic appliances and the first communications network to a specific fixed mode in which the communications units communicate according to a defined protocol; and
the faults and/or blockages occurring in the first communications network are assessed in the transfer device in the course of communications according to the defined protocol.

23. The method according to claim 21, wherein the activating of the test program in the transfer device is triggered from the control and/or monitoring appliance by a separate message sent to the control and/or monitoring appliance by at least one of the domestic appliances and/or occurs from a further communications device assigned to the domestic appliance.

24. The method according to claim 21, wherein the activating of the test program in the transfer device is triggered automatically by the transfer device itself, after the transfer device has assessed faults and/or blockages in the transfer device by sporadic monitoring of the first communications network or monitoring carried out at longer intervals.

25. The method according to claim 21, which further comprises carrying out the activating of the test program, for monitoring the first communications network, for a fixed period of time.

26. The method according to claim 21, which further comprises operating the first communications network as a line-connected communications network including communications lines.

27. The method according to claim 26, wherein the communications lines are power supply lines supplied by a mains voltage source of the domestic appliances.

28. The method according to claim 21, which further comprises operating the communications network as a radio network, over which the individual domestic appliances communicate through send and receive units forming the communications units.

29. The method according to claim 21, which further comprises evaluating recorded faults and/or blockages according to type, extent and duration.

30. The method according to claim 21, which further comprises connecting the first communications network through a second communications network to the external control and/or monitoring appliance.

31. The method according to claim 30, wherein the second communications network is a public communications network.

32. A device for determining occurring faults and/or blockages in communication with domestic appliances, the device comprising:
a first communications network;
communications units connected between said first communications network and the domestic appliances for giving and/or receiving communications signals over said first communications network;
at least one transfer device to be connected to said first communications network for storing a separate test program in said at least one transfer device to permit the faults and/or blockages occurring in said first communications network to be assessed upon activation of said separate test program; and
at least one external monitoring and control appliance to be connected to said at least one transfer device.

33. The device according to claim 32, wherein said test program in said at least one transfer device is activated by said at least one monitoring and control appliance.

34. The device according to claim 32, wherein said at least one monitoring and control appliance loads said test program in said at least one transfer device.

35. The device according to claim 32, wherein said at least one transfer device itself activates said test program in said at least one transfer device, after said at least one transfer device has assessed faults and/or blockages in said first communications network by monitoring said first communications network sporadically or at longer intervals.

36. The device according to claim 32, wherein said at least one transfer device itself loads said test program in said at least one transfer device, after said at least one transfer device has assessed faults and/or blockages in said first communications network by monitoring said first communications network sporadically or at longer intervals.

37. The device according to claim 32, wherein said test program, upon activation, allows the assessed faults and/or blockages to be evaluated according to type, extent and duration.

38. The device according to claim 32, which further comprises a second communications network for connecting said external control and/or monitoring appliance to said at least one transfer device.

39. The device according to claim 38, wherein said second communications network is a public communications network.
